(19) United States
(12) Patent Application Publication
(10) Pub. No.: US 2005/0280717 A1
(43) Pub. Date: Dec. 22, 2005

(54) Image processing system, method and program

(75) Inventor: Masahiko Sugimoto, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/150,246

(22) Filed: Jun. 13, 2005

(30) Foreign Application Priority Data
Jun. 14, 2004 (JP) 2004-174879
Jan. 28, 2005 (JP) 2005-020508

(51) Int. Cl. H04N 5/228

(52) U.S. Cl. 348/222.1

(57) ABSTRACT

If redeye-image correction processing has been applied to image data contained in an image file that has been stored on a memory card, what version of the processing was applied is recorded in the image file. If a digital still camera is capable of executing redeye-image correction processing whose version is newer than that of the redeye-image correction processing that has been applied to the image data contained in the image file recorded on the memory card, then this redeye-image correction of the newer version is executed in a correction processing circuit of the digital still camera. If the redeye-image correction of the newer version cannot be executed in the digital still camera, then this redeye-image correction is not executed.

### BACKGROUND OF THE INVENTION

1. Field of the Invention

This invention relates to an image processing system, method and program.

2. Description of the Related Art

When a flash photo of a person is taken, there are instances where the eyes of the person in the image appear red. This is the so-called “redeye” phenomenon. In an image in which the redeye phenomenon has occurred, the redeye image part of the image is corrected using information such as an indication as to whether or not flash photography was used and the focal length of the imaging lens. For example, see the specification of Japanese Patent Application Laid-Open No. 5-224271 (Patent Reference 1).

Another example of prior art [the specification of Japanese Patent Application Laid-Open No. 11-127371 (Patent Reference 2)] is to detect whether a redeye correction has been performed and inhibit the re-execution of redeye correction processing if correction of redeye has already been carried out.

However, there are instances where even if redeye correction processing has been executed, an even better redeye correction can be performed by redeye correction processing that is newer than the redeye correction processing applied the first time, as when the version of the redeye correction processing circuit (program) has been upgraded.

### DISCLOSURE OF THE INVENTION

Accordingly, an object of the present invention is to execute better image processing in image processing typified by the redeye correction.

According to the present invention, the foregoing object is attained by providing an image processing system having an image processing device (image processing means) for executing prescribed image processing, the apparatus comprising: a first determination device (first determination means) for determining whether image processing that is newer than the prescribed image processing, which has been applied to given image data, can be executed by the image processing device; and an image processing control device, responsive to a determination by the first determination device that the newer image processing can be executed by the image processing device, for controlling the image processing device in such a manner that the newer image processing is applied to the given image data.

The present invention also provides a method suited to the above-described image processing system. Specifically, the invention provides an image processing method in an image processing system having an image processing device for executing prescribed image processing, the method comprising the steps of: determining whether image processing (image processing that has been updated or revised) that is newer than the prescribed image processing, which has been applied to given image data, can be executed by the image processing device; and, in response to a determination that the newer image processing can be executed, controlling the image processing device in such a manner that the newer image processing is applied to the given image data.

The present invention also provides a program (or a recording medium on which the program has been stored) for executing the above-described image processing method.

In accordance with the present invention, an image processing system is provided with an image processing device that executes prescribed image processing. When image data is applied to the system, it is determined whether image processing that is newer than the prescribed image processing that has been applied to the image data can be executed in the image processing device (in a case where no image processing has been executed, it is determined that the newer image processing can be executed). If it is determined that the newer image processing can be executed, then the given image data is subjected to the newer image processing in the image processing device.

In a case where image processing (which has been updated, revised or upgraded) newer than image processing that has already been performed can be executed, the newer image processing is executed. This makes it possible to execute better image processing. Further, in an instance where old image processing (an earlier version of the image processing) will be applied if image processing is executed in the image processing system, this image processing will not be carried out. Image processing is executed in a case where it is necessary.

The image processing system may further comprise a second determination device (second determination means) for determining whether the newer image processing is unnecessary; and a control device, which is responsive to a determination by the second determination device that the newer image processing is unnecessary, for controlling the image processing control device so as to halt control processing of the image processing device.

The image processing system may further comprise a reading device (reading means) for reading image data that has been recorded on a recording medium. In this case, the first determination device would execute the determination processing with regard to image data read from the reading device. The system would further comprise a display control device for controlling a display unit so as to display an image represented by image data that has been subjected to image processing by the image processing device under the control of the image processing control device; a record command input device; and a first recording control device, responsive to input of a record command from the record command input device, for recording image data, which has been subjected to the new image processing by the image processing device under control of the image processing control device, on the recording medium.

Thus, an image that has undergone newer image processing can be displayed on a display unit and the image obtained by the newer image processing can be checked. If the user finds the image obtained by the newer image processing to be favorable, then the image data representing the image obtained by the newer image processing is recorded on the recording medium. If the user finds the image obtained by the newer image processing to be unfavorable, then the image data representing the image that prevailed prior to the application of the newer image processing can be left on the recording medium.

The image processing system further comprises a reading device for reading image data that has been recorded on a recording medium, and the first determination device executes the determination processing with regard to image data read from the reading device. In this case the system may further comprise a selecting device (selecting means) for selecting an overwrite mode or a save-as mode; and a second recording control device (second recording control means), which is responsive to selection of the overwrite mode by the selecting device, for writing image data, which has been subjected to the newer image processing by the image processing device under the control of the image processing control device, over a recording area in which image read by the reading device has been recorded, and which is responsive to selection of the save-as mode by the selecting device, for recording image data, which has been subjected to the newer image processing by the image processing device under the control of the image processing control device, in an available area of the recording medium.

By selecting the overwrite mode, image data that has undergone the newer image processing can be written over image data that was recorded on the recording medium before the newer image processing was executed. By selecting the save-as mode, image data that has undergone the newer image processing can be recorded in an available area of the recording medium.

The image processing system may further comprise a reading device for reading image data that has been recorded on a recording medium. In this case, the system would further comprise a third determination device (third determination means) for determining whether image data that has been subjected to the newer image processing by the image processing device can be recorded in an available area of the recording medium; and a recording control device, responsive to a determination by the third determination device that the image data that has been subjected to the newer image processing can be recorded in an available area of the recording medium, for recording the image data, which has been subjected to the newer image processing by the image processing device under the control of the image processing control device, on the recording medium. Control of the image processing device by the image processing control device would be halted in response to a determination by the third determination device that the image data that has been subjected to the newer image processing cannot be recorded in an available area of the recording medium.

Thus, newer image processing can be executed in a case where image data that has undergone image processing can be recorded in an available area of a recording medium.

The image processing system further comprises a reading device for reading image data that has been recorded on a recording medium, and the first determination device executes the determination processing with regard to image data read from the reading device. In this case the system may further comprise a safe-as mode setting device (safe-as mode setting means) for setting a safe-as mode; a fourth determination device (fourth determination means), which is responsive to setting of the safe-as mode by the safe-as mode setting device, for determining whether image data that has been subjected to the newer image processing by the image processing device can be recorded in an available area of the recording medium; a third recording control device (third recording control means), which is responsive to a determination by the fourth determination device that image data that has been subjected to the newer image processing can be recorded in an available area of the recording medium, for recording the image data, which has been subjected to the newer image processing by the image processing device controlled under the image processing control device, on the recording medium; an overwrite mode setting device (overwrite mode setting means) for setting an overwrite mode; and a fourth recording control device, which is responsive to setting of the overwrite mode by the overwrite mode setting device in a case where it has been determined by the fourth determination device that the image data that has been subjected to the newer image processing cannot be recorded in an available area of the recording medium, for writing image data, which has been subjected to the newer image processing by the image processing device under control performed by the image processing control device, over a recording area in which image data read by the reading device has been recorded.

In a case where the save-as mode has been set, image data that has undergone newer image processing can be recorded in an available area of a recording medium if the recording medium has an available area. If the recording medium has no available area in a case where the save-as mode has been set, the overwrite mode is set. As a result, a recording area in which image data that is to undergo newer image processing has been recorded can be overwritten by image data that has undergone the newer image processing. Thus, image data that has undergone newer image processing can be recorded on a recording medium irrespective of whether or not the recording medium has an available area.

The image processing system may have a fifth determination device (fifth determination means) for determining whether the given image data is to undergo the prescribed image processing. In this case, the first determination device would respond to a determination by the fifth determination device that the applied image data is to undergo the prescribed image processing by determining whether image processing that is newer than the prescribed image processing that has been applied to the applied image data can be executed by the image processing device.

Thus, whether prescribed image processing is new or not is detected after it is checked whether image data is image data that is to undergo image processing. This makes it possible to prevent a version from being checked with regard to data that is not to undergo image processing.

The above-mentioned image processing is redeye-image correction processing, by way of example. In this case, the fifth determination device determines whether the prescribed image processing is to be executed or not based upon flash-photography information or luminance regarding the image represented by the given image data.

The first determination device has an image processing detecting device (image processing detecting means) for detecting what version of the prescribed image processing has been applied to the given image data. In this case, it would be determined that image processing having a version later than that of the image processing detected by the image processing detecting device can be executed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a digital still camera;

FIG. 2 illustrates the structure of a memory card;

FIG. 3 illustrates the structure of an image file;

FIGS. 4 and 5 are flowcharts illustrating processing for correction of a redeye image;

FIGS. 6 to 8 are flowcharts illustrating processing for displaying the image of a subject that has undergone correction of a redeye image; and

FIGS. 9 to 14 illustrate examples of images of a subject displayed on a display screen.

### DESCRIPTION OF THE PREFERRED EMBODIMENT

A preferred embodiment of the present invention will now be described with reference to the drawings.

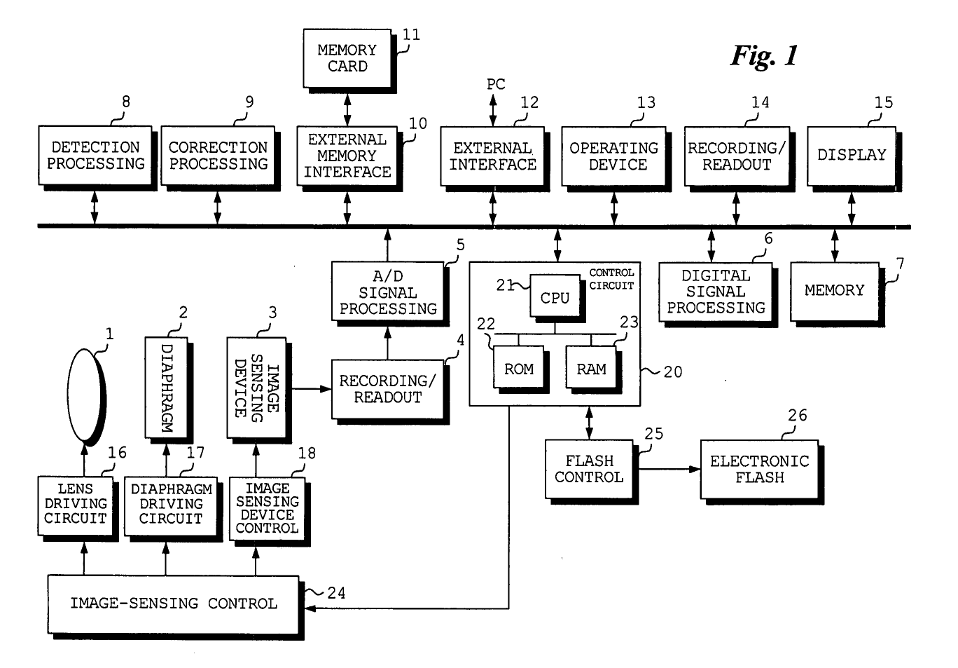

FIG. 1 is a block diagram illustrating the electrical structure of a digital still camera according to the present invention.

A variety of image processing such as a redeye image correction, automatic tone compensation and automatic white balance adjustment can be executed in the digital still camera according to this embodiment. In particular, versions of such image processing have been stored in the digital still camera according to this embodiment. Whether an image to undergo processing has been subjected to the same image processing is detected. If the image has undergone the same image processing, then it is detected whether the image has undergone image processing of a version earlier than that of image processing capable of being executed by the digital still camera. If the image has undergone processing of an earlier version, then the image in the digital still camera is subjected to image processing of a later version. The details will become evident from the description that follows.

The overall operation of the digital still camera is controlled by a control circuit 20.

The control circuit 20 includes a CPU 21, a ROM 22 and a RAM 23 interconnected by a bus. The nature of processing (name of processing) of the image processing executed in the digital still camera, the version of the image processing, other necessary data and image processing programs, etc., have been stored in the ROM 22. The RAM 23 temporarily stores required data, image files that have been read out of a memory card 11, etc.

The digital still camera includes an operating device 13 having a shutter-release button, a mode setting dial (which is capable of setting various modes such as an image sensing mode, a playback mode and a correction mode), an OK button, a CANCEL button, FRAME button, a BEFORE button and an AFTER button, etc. An operating signal that is output from the operating device 13 is input to the control circuit 20. A personal computer is capable of being connected to the digital still camera, which is provided with an external interface 12 for this purpose.

The digital still camera includes an image sensing lens 1 for sensing the image of a subject, a diaphragm 2 and an image sensing device 3 such as a CCD. The lens position of the image sensing lens 1 is controlled by a lens driving circuit 16. The aperture of the diaphragm 2 is controlled by a diaphragm driving circuit 17. A light beam representing the image of a subject is condensed by the image sensing lens 1 and impinges upon the image sensing device 3 such as the CCD through the diaphragm 2. A light image representing the image of the subject is formed on the photoreceptor surface of the image sensing device 3, which is controlled by a control circuit 18 for the image sensing device 3. The lens driving circuit 16, diaphragm driving circuit 17 and control circuit 18 are controlled by an image-sensing control circuit 24.

If the image sensing mode is set by the mode setting dial 20, the image sensing device 3 is controlled by a control circuit 18 and the image sensing device 3 outputs a video signal representing the image of the subject. The video signal is subjected to analog signal processing such as correlated double sampling in an analog signal processing circuit 4. The video signal that is output from the analog signal processing circuit 4 is converted to digital image data in an analog/digital signal processing circuit 5 and the digital image data is input to a digital signal processing circuit 6. Digital signal processing such as a gamma correction, automatic tone compensation and white balance adjustment is executed in the digital signal processing circuit 6.

The image data that has been output from the digital signal processing circuit 6 is applied to a display unit 15 via a memory 7. The image of the subject is displayed on the display screen of a display unit 15.

If the shutter-release button is pressed, the image of the subject is sensed again and image data representing the image of the subject is obtained in a manner similar to that described above. This image data is applied from the digital signal processing circuit 6 to the memory 7, where the image data is stored temporarily. The image data is read out of the memory 7 and recorded on the memory card 11, which is connected to an external memory interface 10, by a recording/readout control circuit 14. It goes without saying that the image data may be subjected to data compression as necessary and the compressed image data recorded on the memory card 11.

If a playback mode is set by the mode setting dial, image data representing the image of the subject is read out of the memory card 11 by the recording/readout control circuit 14. The image data that has been read out is applied to and stored temporarily in the memory 7. The image data is read out of the memory 7 and applied to the display unit 15. The image represented by the image data that has been recorded on the memory card 11 is displayed on the display screen of the display unit 15.

If the correction mode is set by the mode setting dial, then correction of a redeye image is performed in this embodiment (it may be so arranged that other image processing such a detection of a face image is executed, as a matter of course). If image data (an image file) is read out of the memory card 11, a detection processing circuit 8 detects whether this image data has undergone redeye-image correction processing and, if the image data has undergone redeye-image correction processing, detects what version of the redeye-image correction processing was executed.

The detected version of the redeye-image correction processing and the version of the redeye-image correction processing in the digital still camera are compared. If the version of the redeye-image correction processing in the digital still camera is later than the version of the redeye-image correction processing that has been applied to the image data read out of the memory card 11, then redeye-image correction processing (new image processing) is executed in a correction processing circuit 9 of the digital still camera. Conversely, if the version of the redeye-image correction processing in the digital still camera is earlier than the version of the redeye-image correction processing that has been applied to the image data read out of the memory card 11, then redeye-image correction processing in the correction processing circuit 9 of the digital still camera is not executed.

Image data that has undergone the redeye-image correction processing is applied to the display unit 15 and displayed on the display screen.

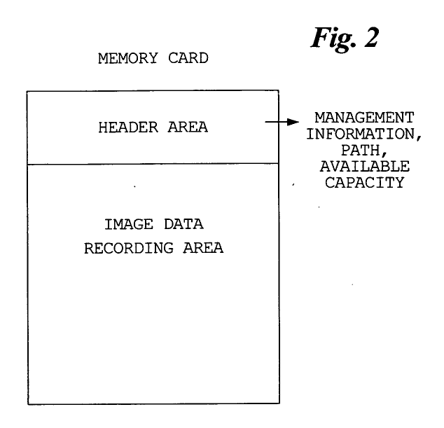

FIG. 2 illustrates an example of the data structure of the memory card 11.

The memory card 11 includes a header area and an image-data recording area.

Image data has been recorded in the image-data recording area as described above. The header area contains management information for managing the entire memory card 11, as well as data indicating the path of image data recorded in the image-data recording area and the available capacity (residual capacity) of the image-data recording area.

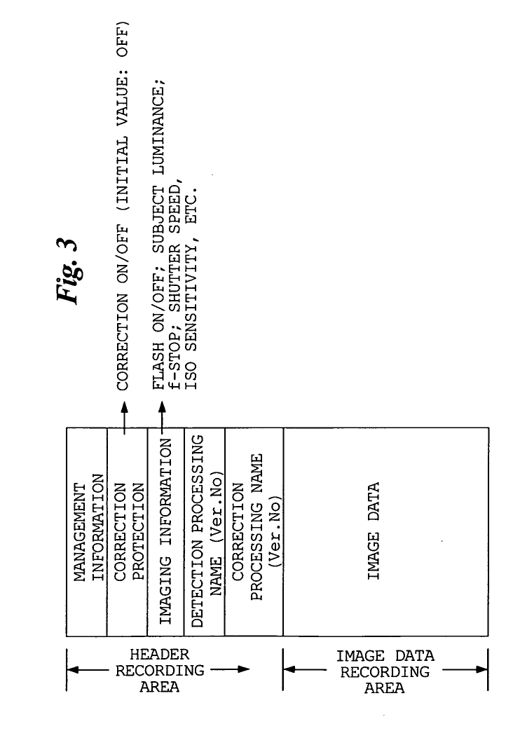

FIG. 3 illustrates an example of the file structure (data structure) of an image file that has been recorded on the memory card 11.

The image file includes a header recording area and an image data recording area.

Image data has been stored in the image data recording area.

Data such as for managing the overall image file has been stored in the header recording area. Also stored in the header recording area is data such as management information, correction protection, photography information, name of detection processing and name of correction processing.

The management information is for managing the overall image file. As mentioned above, there are cases where a redeye-image correction regarding image data (an image file) that has been recorded on the memory card 11 is and is not executed, depending upon the version. Correction protection is for the purpose of making a setting to the effect that the redeye-image correction is to be inhibited regardless of the version. The redeye-image correction is inhibited if correction protection is ON, and is or is not performed, depending upon the version, if correction protection is OFF. The initial value of correction protection (the value which prevails if the redeye-image correction has not been performed a single time) is set to be OFF. The photography information indicates photography information that prevailed at the time the image data, which has been recorded in the image data recording area, was obtained. The photography information contains flash ON/OFF, which indicates whether the image was acquired by flash photography, the luminance of the subject of the image represented by the image data, the f-stop value, shutter speed and ISO sensitivity, etc.

The name of detection processing contains the name of detection processing that was executed with regard to the image data that has been recorded in the image data recording area, and the version of this detection processing. In a case where a plurality of types of detection processing (redeye-image detection processing, face-image detection processing, etc.) have been executed, the names of these types of processing are included. It may be so arranged that in a case where detection processing of the same type has been executed a plurality of times, a history of these multiple executions of the detection processing is included. With regard to the name of correction processing, in a case where there have been-executed a plurality of types of correction processing (redeye-image correction processing, automatic tone correction processing, automatic white balance adjustment processing, etc.) for which a name and version of detection processing that has been applied to the image data recorded in the image data recording area have been stored, the names of these types of detection processing are included. It may be so arranged that in a case where correction processing of the same type has been executed a plurality of times, a history of these multiple executions of the detection processing is included. In a case where neither detection processing nor correction processing has been executed a single time, this section of the header recording area will be blank.

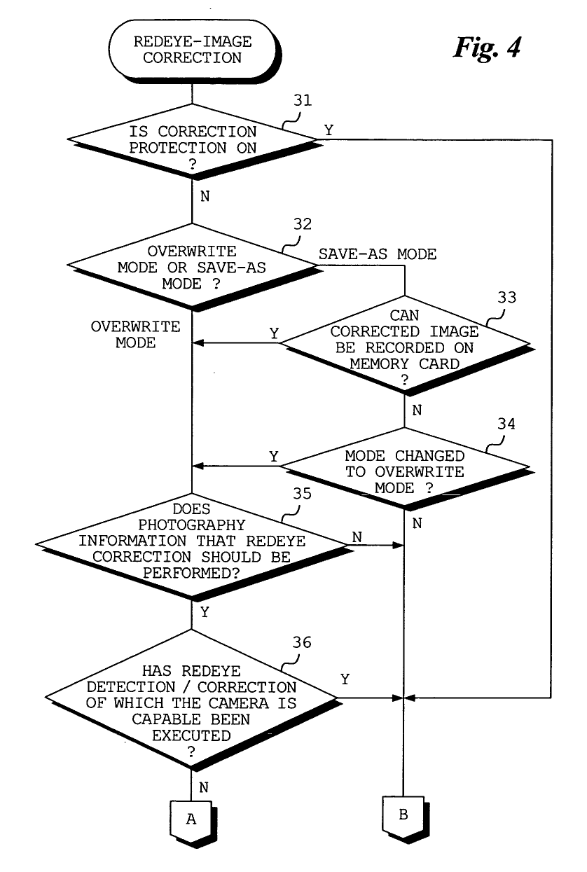

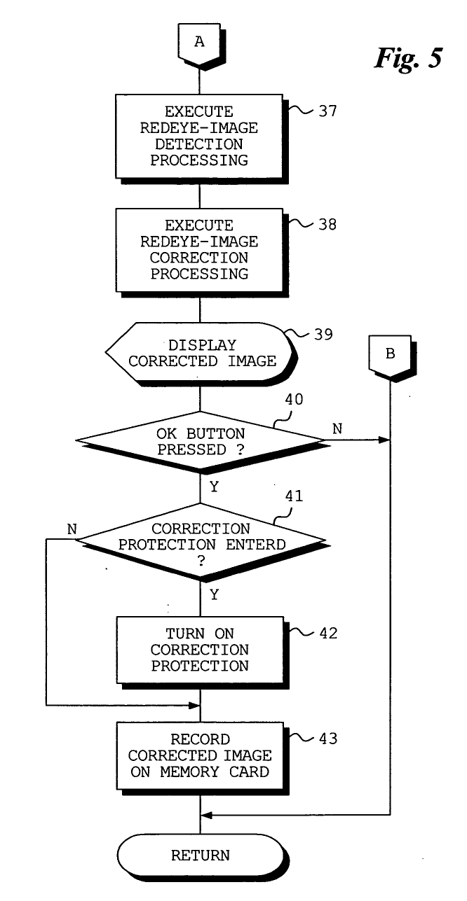

FIGS. 4 and 5 are flowcharts illustrating redeye-image correction processing.

A desired image file is read out the memory card 11 and stored temporarily in the RAM 23 of the digital still camera. The correction protection is read out of the header recording area of the image file stored in the RAM 23 and it is determined whether the correction protection is ON (i.e., whether the redeye-image correction is inhibited). If the correction protection is ON (“YES” at step 31), then it is construed that the redeye-image correction is unnecessary with regard to the image represented by the image data that has been stored in the image file and therefore subsequent redeye-image correction processing is skipped. If correction protection is OFF (“NO” at step 31), then it is determined whether the overwrite mode, in which an image file that will be obtained by redeye-image correction processing to be executed is written over an image file prevailing prior to execution of this redeye-image correction processing, has been set (this mode has been set in advance using various setting menus displayed on the display screen of the display unit 15), or whether the save-as mode, in which image data representing an image that has undergone redeye-image correction processing will be recorded in an available area of the memory card, has been set (step 32). Of course, it may be so arranged that even if the save-as mode cannot be set, the save-as mode is regarded as having been set in response to the overwrite mode not having been set.

In a case where the save-as mode has been set (step 32), the image file that has undergone the redeye-image correction processing can be recorded in the memory card 11 if the memory card 11 has enough available capacity. In order to accomplish this, it is determined whether the memory card 11 has enough available capacity to record the image file that has undergone redeye-image correction processing (step 33). If there is not enough available capacity to allow recording of the image file (“NO” at step 33), then it is determined whether the mode has been changed to the overwrite mode in order to make it possible to record the image file that has undergone redeye-image correction processing on the memory card 11 (step 34). It goes without saying that an indication to change the mode to the overwrite mode because the image file that has undergone redeye-image correction processing cannot be recorded on the memory card 11 owing to inadequate available capacity is displayed on the display screen of the display unit 15. If the mode is not changed to the overwrite mode (“NO” at step 34), then the image file that has undergone redeye-image correction processing cannot be recorded on the memory card 11 and, hence, redeye-image correction is skipped.

If the mode has been set to the mode for writing an image file, which will be obtained by redeye-image correction processing to be executed, over an image file that prevailed prior to execution of this redeye-image correction processing (“OVERWRITE MODE” at step 32, or “YES” at step 34), or if the memory card 11 has enough available capacity to allow recording of the image file that results from the redeye-image correction processing (“YES” at step 33), then photography information that has been recorded in the header information of the image file stored in RAM 23 is read. On the basis of the read photography information, it is determined whether the image data that has been stored in the image file is image data to undergo redeye-image correction processing (step 35). For example, if the electronic flash is ON and the subject has a low luminance, then a decision is made to execute redeye-image correction processing. If the electronic flash is ON but the subject has a high luminance, then a decision is made not to execute redeye-image correction processing. As for the subject luminance contained in the photography information, a BV value can be used if the BV value has been stored, or the luminance can be calculated from the f-stop (AV value), shutter speed (TV value) and ISO sensitivity (SV value) (exposure EV value=AV value+TV value=BV value+SV value). If it is determined that the redeye-image correction processing will not be executed (“NO” at step 35), then subsequent redeye-image correction processing is skipped.

If it is determined that redeye-image correction processing is to be executed (“YES” at step 35), then the version of the redeye detection processing (name of detection processing) and the version of the redeye-image correction processing (name of correction processing), which have been recorded in the header recording area of the image file, the version of the redeye detection processing that will be executed in the redeye detection processing circuit 8 of the digital still camera and the version (stored in ROM 22) of the redeye-image correction processing that will be executed in the redeye-image correction processing circuit 9 are compared.

If the version that has been stored in the ROM 22 of the digital still camera is earlier than the version that has been stored in the image file, it is construed that redeye-image correction processing newer than the redeye-image correction processing that can be executed in the digital still camera has already been carried out (“YES” at step 36). Since it is construed that redeye-image correction processing better than the redeye-image correction processing that has already been executed cannot be executed in the digital still camera, redeye-image correction processing in the digital still camera is skipped. If the version that has been stored in the ROM 22 of the digital still camera is later than the version that has been stored in the image file (i.e., if the version of either the redeye-image detection processing or the version of the redeye-image correction processing is later), it is construed that redeye-image correction processing newer than the redeye-image correction processing that has already been carried out can be executed in the digital still camera (“NO” at step 36). Since it is construed that redeye-image correction processing newer than the redeye-image correction processing that has already been executed can be executed in the digital still camera, control transitions to redeye-image correction processing in the digital still camera.

First, the image data contained in the image file is applied to the detection processing circuit 8 and the newer redeye-image detection processing is executed (step 37). Although the redeye-image detection processing is executed as by performing matching between a sample image assumed to be a redeye image and the image to undergo redeye-image correction processing, it goes without saying that any detection processing may be employed.

If a redeye image is detected in the detection processing circuit 8, the image data is applied to the correction processing circuit 9 and the newer redeye-image correction processing is executed with regard to the detected redeye image (step 38). Although the redeye-image correction processing can be implemented by applying a color correction or luminance correction, etc., to the detected redeye portion of the image, this may be any correction processing.

The image data obtained by the redeye-image correction processing is applied to and stored temporarily in memory 7. The image data that has undergone the redeye-image correction processing is read from the memory 7 and applied to the display unit 15, whereby the image that has undergone the redeye-image correction is displayed on the display screen of the display unit 15 (step 39). The image data that has been stored in the memory 7 is written over the image data recording area of the image file that has been stored in RAM 23.

The user observes the displayed image and presses the CANCEL button if the image that has undergone the redeye-image correction is unfavorable (“NO” at step 40). This prevents a situation in which image data representing an image that has undergone the redeye-image correction is recorded on the memory card anew despite the fact that the user finds the image unfavorable. Thus, the image data that has already been recorded on the memory card remains preserved on the card. In a case where image data representing an image that has undergone the redeye-image correction is to be recorded on the memory card, the user presses the OK button (i.e., enters a record command) (“YES” at step 40).

If the user believes that no further redeye-image correction processing is necessary, correction protection is entered from the operating device 13 (“YES” at step 41). The entered correction protection is applied to the image file that has been stored in RAM 23 and correction protection in the header recording area of this image file is turned ON (step 42). Further, it goes without saying that the version of the detection processing circuit 8 and the version of the correction processing circuit 9 in the digital still camera also are recorded in the name of detection processing and name of correction processing, respectively, of the image file.

The new image file in which image data that has undergone the redeye-image correction processing is read out of RAM 23 and recorded on the memory card 11 (step 43). If the overwrite mode has been set, the new image file is written over the area in which the image file that was read out has been recorded. If the overwrite mode has not been set, then the new image file is recorded in an available area of the memory card 11.

In the above-described embodiment, redeye-image correction processing is taken up as an example of image processing. However, it goes without saying that the invention is also applicable to image processing such as face detection processing and automatic tone compensation processing, etc., and other types of such detection processing and compensation processing. Further, although detection processing is handled as processing separate from correction processing in the above embodiment, these kinds of processing may be dealt with collectively as one kind of processing. Furthermore, it may be so arranged that an image for which correction protection has been turned ON can have this turned OFF by use of the operating device 13.

Furthermore, in the above-described embodiment, whether image data that has been recorded on the memory card 11 is to be subjected to redeye-image detection processing and redeye-image correction processing in the digital still camera is judged utilizing the version. However, it will suffice to know whether the digital still camera can perform redeye-image detection processing and redeye-image correction processing newer than redeye-image detection processing and redeye-image correction processing that has been applied to image data that has been stored on the memory card 11. For example, instead of relying upon the version, it is also possible to utilize the dates on which the operating programs of the detection processing circuit 8 and correction processing circuit 9 were updated.

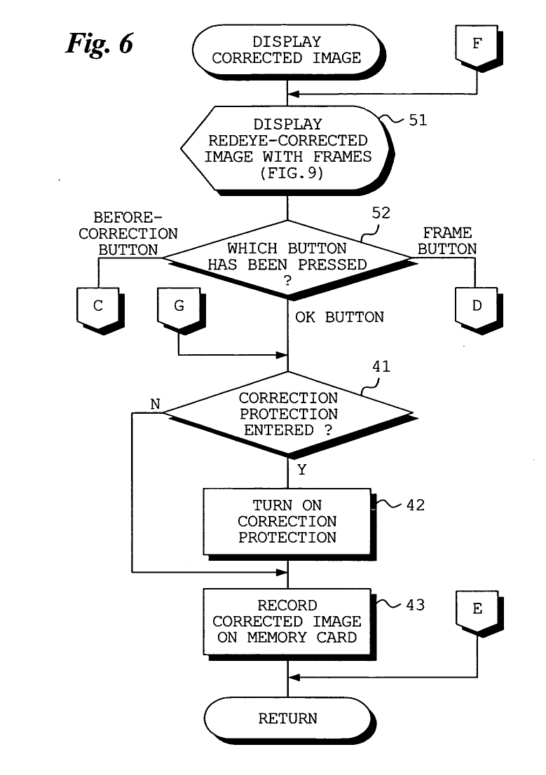

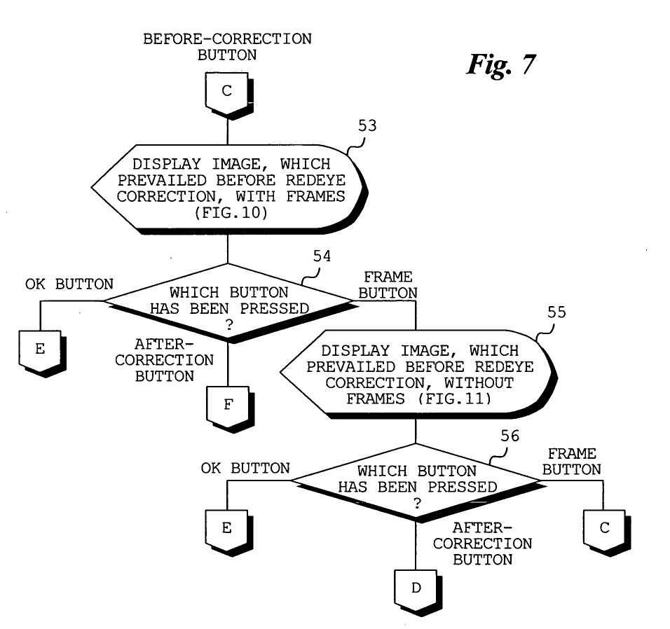

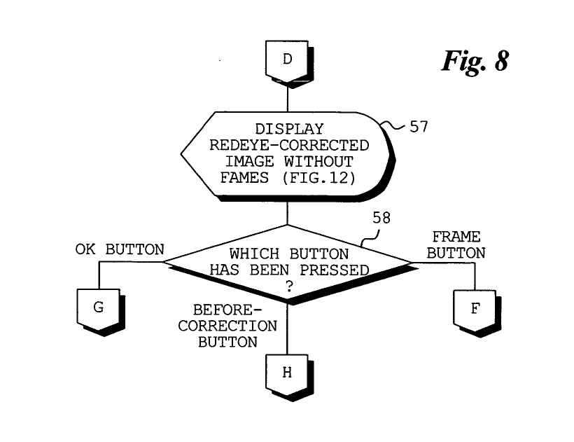

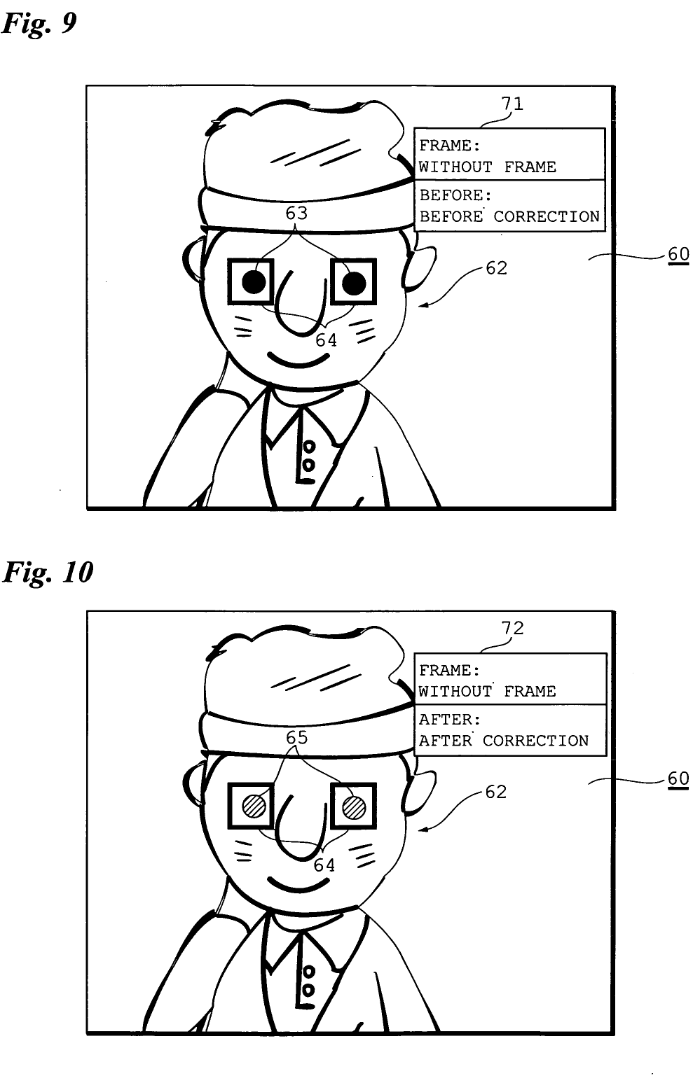

FIGS. 6 to 8 are flowcharts illustrating processing for displaying an image that has undergone a redeye-image correction, and FIGS. 9 to 12 illustrate the manner in which the image of a subject is displayed on the display screen of the display unit 15.

Whereas the processing described above merely displays an image (step 39 in FIG. 5) that has undergone the redeye-image correction, the processing illustrated below notifies the user of the portion of a redeye image that has been corrected and the portion of a redeye image that is to be corrected. This is done by use of an enclosing frame (although it goes without saying that an enclosing frame need not be employed). The user can tell at a glance which portion has been corrected and which portion is to be corrected.

If redeye-image detection processing (step 37 in FIG. 5) and redeye-image correction (step 38 in FIG. 5) is performed as described above, the image of the subject having the detected portion of the redeye image enclosed by an enclosing frame is displayed on the display screen of the display unit 15 (step 51), as illustrated in FIG. 9.

As shown in FIG. 9, an image 62 of a subject being displayed on a display screen 60 includes portions 63 that have been corrected for redeye. The portions 63 that have been corrected for redeye are enclosed by frames 64 and therefore the user can tell at a glance which portions have undergone the redeye correction.

An operating window 71 is being displayed at the upper right of the display screen 60. Characters reading “FRAME: WITHOUT FRAME” and “BEFORE: BEFORE CORRECTION” are being displayed in the operating window 71. It will be understood by observing the operating window 71 that the FRAME button should be pressed in a case where the subject image 62 from which the frames 64 have been removed is to be displayed on the display screen 60, and that the BEFORE button should be pressed in a case where the subject image 62 that prevailed prior to the redeye correction is to be displayed. By pressing the OK button, image data representing the subject image 62 that has undergone redeye-image correction processing is recorded on the memory card 11. By pressing the CANCEL button, image data representing the subject image 62 that has undergone redeye-image correction anew is not recorded on the memory card 11.

In FIG. 6, with the subject image 62 that has undergone the redeye-image correction being displayed on the display screen 60, it is determined which button has been pressed (step 52). If the OK button is pressed, input of correction protection is checked, correction protection is turned ON and the processing for recording on the memory card 11 the image data representing the subject image that has undergone the redeye-image correction is executed (steps 41 to 43 in FIG. 5), as described above (image data representing the images of the frames 63 per se is not recorded).

If the BEFORE button is pressed, the subject image 62 that prevailed before the redeye correction of the redeye image portions 63 is displayed on the display screen 60 with the frames 63 attached thereto (step 53), as illustrated in FIG. 10.

In FIG. 10, the subject image 62 being displayed on the display screen 60 includes portions 65 that have not been corrected for redeye. The portions 65 not corrected for redeye are enclosed by the frames 64 and therefore the user can tell at a glance which portions are to be corrected for redeye. An operating window 72 is displayed at the upper right of the subject image 62. Characters reading “FRAME: WITHOUT FRAME” and “AFTER: AFTER CORRECTION” are being displayed in the operating window 72. It will be understood by observing the characters in the operating window 72 that the FRAME button should be pressed in a case where the subject image 62 from which the frames 64 have been removed is to be displayed on the display screen 60, and that the AFTER button should be pressed in a case where the subject image that has undergone the redeye-image correction is to be displayed.

With the image that prevailed prior to the redeye correction being displayed with the frames attached, which button has been pressed is checked again (step 54). If the OK button is pressed, it is construed that the user has decided that the subject image that prevailed prior to the redeye-image correction is satisfactory. Image data representing the new image that has been corrected for redeye, therefore, is not recorded on the memory card 11. The image data representing the new image that prevailed prior to the redeye correction remains on the memory card 11. If the AFTER button is pressed, then the image that has undergone the redeye correction is again displayed on the display screen 60 with the frames attached thereto (step 51). If the FRAME button is pressed, then the image that prevailed prior to the redeye-image correction is displayed without the frames (step 55), as illustrated in FIG. 11.

If the FRAME button has been pressed, a subject image 66 that prevailed prior to the correction of the redeye-image portions 65 is displayed on the display screen 60 without frames (step 55). An operating window 73 is displayed at the upper right of the subject image 66. Characters reading “FRAME: WITH FRAME” and “AFTER: AFTER CORRECTION” are being displayed in the operating window 73. It will be understood by observing the characters in the operating window 73 that the FRAME button should be pressed in a case where frames are to be displayed about the redeye-image portions 65, and that the AFTER button should be pressed in a case where the subject image that has undergone the redeye-image correction is to be displayed.

If any button is pressed in a case where the subject image 66 shown in FIG. 11 is being displayed, which button has been pressed is determined again (step 56). If the OK button is pressed, it is construed that the user does not intend to record on the memory card 11 the image data representing the new subject image that has undergone the redeye correction. Accordingly, the processing whereby the image data representing the subject image that has undergone the redeye correction is recorded on the memory card 11 is skipped. If the FRAME button is pressed, the image data that prevailed prior to the redeye correction is again displayed on the display screen 60 with the frames attached thereto.

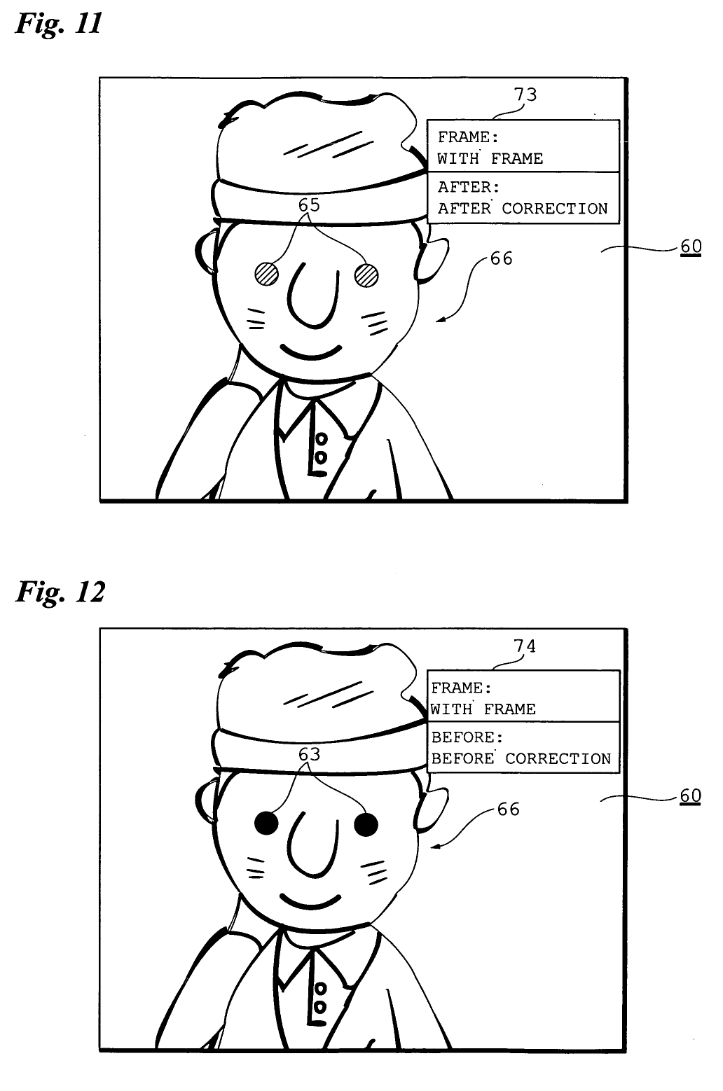

If the AFTER button is pressed in a case where the subject image 66 that prevailed prior to the redeye correction is being displayed on the display screen 60 without the frames, as illustrated in FIG. 11, or if the FRAME button is pressed in a case where the subject image 62 that has undergone the redeye correction is being displayed with the frames attach thereto, as illustrated in FIG. 9, then the subject image that has undergone the redeye correction will be displayed on the display screen 60 without the frames, as illustrated in FIG. 12 (step 57).

As shown in FIG. 12, an operating window 74 is being displayed at the upper right of the display screen 60. Characters reading “FRAME: WITH FRAME” and “BEFORE: BEFORE CORRECTION” are being displayed in the operating window 74. The user can ascertain that pressing the FRAME button will cause frames to be displayed about portions 63 that have been corrected for redeye and that pressing the BEFORE button will cause the subject image that prevailed before the correction to be displayed on the display screen 60.

Which button has been pressed is determined again (step 58). If the OK button has been pressed, this means that the user intends to record on the memory card 11 the image data representing the subject image that has undergone the redeye correction. Entry of the above-described correction protection, therefore, is checked (steps 40 to 42). If the BEFORE button has been pressed, then the subject image that prevailed before the redeye-image correction is displayed on the display screen 60 (step 55). If the FRAME button has been pressed, the subject image that has undergone the redeye correction is displayed on the display screen 60 with the frames attached thereto.

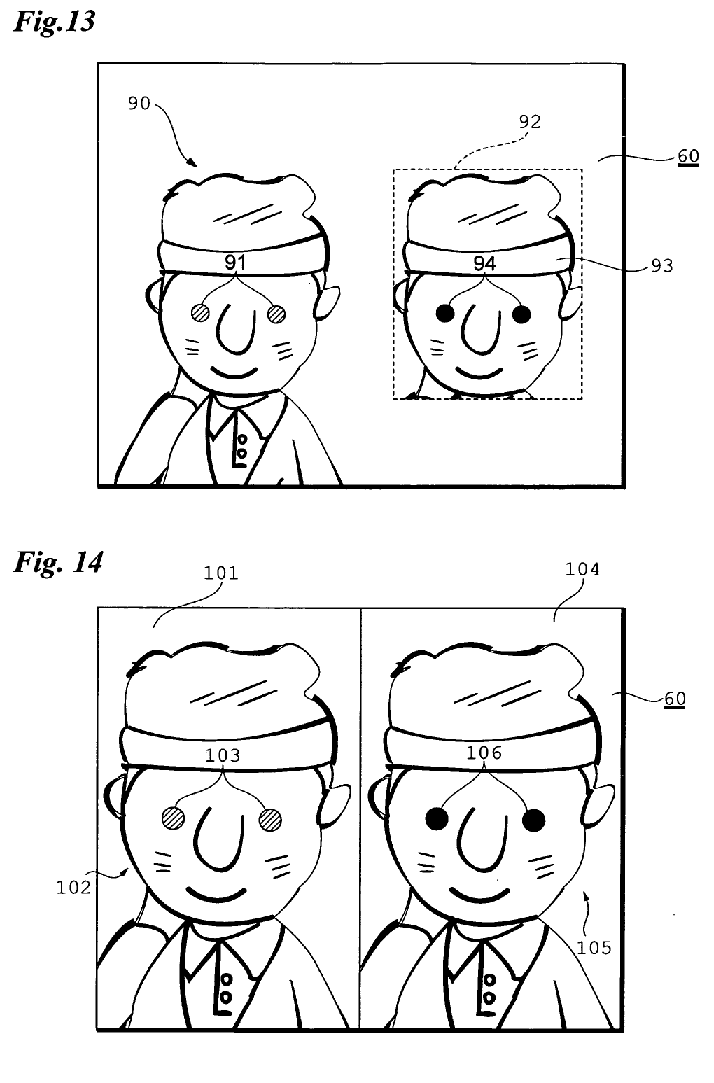

FIG. 13 illustrates an example of a subject image displayed on the display screen 60 according to another embodiment of the invention.

In the embodiment described above, a subject image that has undergone a redeye-image correction and a subject image that prevailed before the redeye-image correction are not displayed on the same screen simultaneously. In the embodiment illustrated below, however, a subject image that has undergone a redeye-image correction and a subject image that prevailed before the redeye-image correction are displayed on the same display screen simultaneously.

A corrected-image display area 92 is defined on the right side of the display screen 60 of display unit 15. The entirety of a subject image 90 before correction for redeye images 91 is being displayed on the display screen 60 in an area that excludes the corrected-image display area 92.

An image 93 that is one part of the subject image that includes image portions 94 corrected for redeye is being displayed in the corrected-image display area 92. The part of the subject image that is the redeye images 94 obtained by processing for detecting the redeye images 91 is construed as being the approximate center of the image 93 that is one part of the subject image, and the image 93 can be construed as being the part of the image surrounding the images 94 at center.

Since the subject image 90 that prevailed before the redeye-image correction and the corrected portions 94 of the redeye images 91 can be displayed on the same display screen simultaneously, the images before and after correction become easier to compare.

It goes without saying that image superimposing processing executable in the digital signal processing circuit 6 of the digital still camera need only be utilized in order to generate the corrected-image display area 92 on the display screen 60.

FIG. 14 illustrates an example of a subject image displayed on the display screen 60 according to still another embodiment of the invention.

Here the display screen 60 is split into identically sized first and second display areas 101, 104 on left and right sides, respectively.

A subject image 102 before redeye images 103 are corrected is being displayed in the first display area 101. A subject image 105 having image portions 106 obtained by correcting the redeye images is being displayed in the second display area 104.

The subject images 102 and 105 before and after redeye-image correction can be displayed on the same display screen simultaneously in this manner as well so that the subject images 102 and 105 before and after redeye-image correction can be compared directly.

A display method of this kind can be implemented by utilizing image superimposing processing executable in the digital signal processing circuit 6 of the digital still camera.

As many apparently widely different embodiments of the present invention can be made without departing from the spirit and scope thereof, it is to be understood that the invention is not limited to the specific embodiments thereof except as defined in the appended claims.

1. An image processing system having an image processing device for executing prescribed image processing, comprising:
a first determination device for determining whether image processing that is newer than the prescribed image processing, which has been applied to given image data, can be executed by the image processing device; and
an image processing control device, responsive to a determination by said first determination device that the newer image processing can be executed by the image processing device, for controlling the image processing device in such a manner that the newer image processing is applied to the given image data.

2. The system according to claim 1, further comprising:
a second determination device for determining whether the newer image processing is unnecessary; and
a control device, which is responsive to a determination by said second determination device that the newer image processing is unnecessary, for controlling said image processing control device so as to halt control of the image processing device.

3. The system according to claim 1, further comprising:
a reading device for reading image data that has been recorded on a recording medium;
said first determination device executing the determination processing with regard to image data that has been read from said reading device;
a display control device for controlling a display unit so as to display an image represented by image data that has been subjected to image processing by the image processing device under the control of said image processing control device;
a record command input device for inputting a record command; and
a first recording control device, responsive to input of the record command from said record command input device, for recording image data, which has been subjected to the newer image processing by the image processing device under control of said image processing control device, on the recording medium.

4. The system according to claim 1, further comprising:
a reading device for reading image data that has been recorded on a recording medium;
said first determination device executing the determination processing with regard to image data that has been read from said reading device;
a selecting device for selecting an overwrite mode or a save-as mode; and
a second recording control device, which is responsive to selection of the overwrite mode by said selecting device, for writing image data, which has been subjected to the newer image processing by the image processing device under the control of said image processing control device, over a recording area in which image data read by said reading device has been recorded, and which is responsive to selection of the save-as mode by said selecting device, for recording image data, which has been subjected to the newer image processing by the image processing device under the control of said image processing control device, in an available area of the recording medium.

5. The system according to claim 1, further comprising:
a reading device for reading image data that has been recorded on a recording medium;
a third determination device for determining whether image data that has been subjected to the newer image processing by the image processing device can be recorded in an available area of the recording medium; and
a recording control device, responsive to a determination by said third determination device that the image data that has been subjected to the newer image processing can be recorded in an available area of the recording medium, for recording the image data, which has been subjected to the newer image processing by the image processing device under the control of said image processing control device, on the recording medium;
control of the image processing device by said image processing control device being halted in response to a determination by said third determination device that the image data that has been subjected to the newer image processing cannot be recorded in an available area of the recording medium.

6. The system according to claim 1, further comprising:
a reading device for reading image data that has been recorded on a recording medium;
said first determination device executing the determination processing with regard to image data that has been read from said reading device;
a safe-as mode setting device for setting a safe-as mode;
a fourth determination device, which is responsive to setting of the safe-as mode by said safe-as mode setting device, for determining whether image data that has been subjected to the newer image processing by the image processing device can be recorded in an available area of the recording medium;
a third recording control device, which is responsive to a determination by said fourth determination device that image data that has been subjected to the newer image processing can be recorded in an available area of the recording medium, for recording the image data, which has been subjected to the newer image processing by the image processing device controlled under said image processing control device, on the recording medium;
an overwrite mode setting device for setting an overwrite mode; and
a fourth recording control device, which is responsive to setting of the overwrite mode by said overwrite mode setting device in a case where it has been determined by said fourth determination device that the image data that has been subjected to the newer image processing cannot be recorded in an available area of the recording medium, for writing image data, which has been subjected to the newer image processing by the image processing device under control performed by said image processing control device, over a recording area in which image data read by said reading device has been recorded.

7. The system according to claim 1, further comprising:
a fifth determination device for determining whether the given image data is to undergo the prescribed image processing;
wherein said first determination device responds to a determination by said fifth determination device that the applied image data is to undergo the prescribed image processing by determining whether image processing that is newer than the prescribed image processing that has been applied to the applied image data can be executed by the image processing device.

8. The system according to claim 7, wherein the prescribed image processing is redeye-image correction processing; and
said fifth determination device determines whether the prescribed image processing is to be executed or not based upon flash-photography information or luminance regarding the image represented by the given image data.

9. The system according to claim 1, wherein said first determination device has an image processing detecting device for detecting what version of the prescribed image processing has been applied to the given image data;
said first determination device determining that the newer image processing can be executed by determining that image processing having a version later than that of the image processing detected by said image processing detecting device can be executed.

10. An image processing method in an image processing system having an image processing device for executing prescribed image processing, comprising the steps of:
determining whether image processing that is newer than the prescribed image processing, which has been applied to given image data, can be executed by the image processing device; and
in response to a determination that the newer image processing can be executed, controlling the image processing device in such a manner that the newer image processing is applied to the given image data.

11. A program for controlling an image processing system having an image processing device for executing prescribed image processing, said program comprising code for implementing the following steps:
determining whether image processing that is newer than the prescribed image processing, which has been applied to given image data, can be executed by the image processing device; and
in response to a determination that the newer image processing can be executed, controlling the image processing device in such a manner that the newer image processing is applied to the given image data.
